(19) United States
(12) Patent Application Publication
(10) Pub. No.: US 2026/0296935 A1
(43) Pub. Date: Oct. 1, 2026

(54) SYSTEM AND METHOD FOR METHANE ELIMINATION IN SEPTIC SYSTEMS AND METHOD TO CREATE CARBON CREDITS OR THEIR EQUIVALENT

(71) Applicant: Jerome Jay Fife, Occidental, CA (US)

(72) Inventor: Jerome Jay Fife, Occidental, CA (US)

(21) Appl. No.: 19/572,637

(22) Filed: Mar. 19, 2026

Related U.S. Application Data
(60) Provisional application No. 63/779,886, filed on Mar. 28, 2025.

(51) Int. Cl. C02F 3/06; B01F 23/231; C02F 7/00

(52) U.S. Cl. CPC C02F 3/06; C02F 7/00; B01F 23/231244

(57) ABSTRACT

A system and method for reducing or eliminating methane emissions in on-site wastewater systems and other aquatic environments are disclosed. A floating/suspended incubator aeration device positioned in wastewater includes an outer housing, a self-cleaning microfine bubble diffuser connected to an external air pump, buoyant and counterbalanced structures configured to position the device at an operational depth during aeration, and a bacteria host material disposed above the diffuser. Air and wastewater move upward through the host material, which is shaped and configured to form a temporary foam that exposes colonized bacteria to atmospheric gaseous non-depletable oxygen within the device while also oxygenating surrounding wastewater. Organic solids are biologically digested and methanogenic precursors are reduced or eliminated, thereby reducing methane emissions, sludge accumulation, and pumping requirements. The device is installable through existing access ports in septic tanks, cesspools, cesspits, seepage pits, treatment tanks on sewer laterals, and other organic-rich aquatic environments. Methane elimination achieved may be modeled for carbon credit accounting.

### CROSS-REFERENCE TO RELATED APPLICATIONS

The present application claims the benefit of U.S. Provisional Application No. 63/779,886 filed on Mar. 28, 2025. The entire disclosure of the aforementioned provisional application is incorporated herein by reference in its entirety.

### BACKGROUND OF THE INVENTION

### 1. Field of the Invention

The present invention relates generally to on-site wastewater treatment in a septic tank, tangentially a cesspool, seepage pit and, more specifically, to a method of using a floating/suspended microbial incubator aeration device having a gaseous non-depletable atmospheric oxygen environment distinct from the surrounding liquid; providing the required oxygen environment for the introduced metabolically superior natural soil bacteria to colonize, flourish and maintain exponential or log phase reproduction; the elimination, not removal, of all organic solids entering a septic tank daily by bacteria digestion during the incubation process. With the elimination of organic solids from a septic tank, methanogenesis cannot occur and the need for pumping septic tanks and other aquatic environments containing organic solids is no longer required. This is a unique and consistent means of creating CO2 equivalent credits (CO2e) from septic systems and wastewater plants.

### 2. Description of Related Art

Septic systems are used worldwide for decentralized wastewater treatment, especially in rural and suburban areas. These systems typically depend on anaerobic digestion in a septic tank, which naturally produces methane, a potent greenhouse gas that contributes significantly to global climate change.

Methane is generated through natural and human sources. According to the 2021 assessment by the Climate and Clean Air Coalition and the United Nations Environment Programme over 50% of global methane emissions are caused by human or anthropogenic activity. Controlling methane emissions is essential for addressing the climate crisis because methane is a more potent heat retention gas than carbon dioxide though methane lasts for a shorter period in the atmosphere. The combination of methane's potency and relatively short atmospheric lifespan means that reducing methane emissions delivers the greatest potential to rapidly curb greenhouse gas induced climate change and stabilize global temperatures.

20% of anthropogenic methane emissions come from waste management systems, solid waste landfills and sewage treatment. This is due to the methanogenic microbes present in anaerobic wastewater treatment facilities including septic tanks and anaerobic conditions within landfills releasing methane as they decompose the waste. This process generates massive amounts of methane in a short period of time. Because of population growth and projected development in poorer countries, methane emissions from waste are expected to grow faster than from any other anthropogenic methane source.

Methane emissions present both a threat and an opportunity. Because methane is so much more potent than carbon dioxide at trapping heat in the atmosphere, it can turbocharge the global warming that is already raising atmospheric and ocean temperatures, driving more extreme storms and other weather events and creating natural uncontrollable positive feedback loops producing even more methane. However, methane's shorter atmospheric lifespan means that acting promptly to cut controllable anthropogenic methane emissions would enable us to make important and timely headway on combating the broadening climate crisis.

Conventional septic systems not only emit large amounts of methane to the atmosphere, but their maintenance requires periodic pumping to remove accumulated solids, which adds operational costs and generates further emissions through fuel combustion and waste disposal.

Therefore, a universal, affordable, and nearly trouble-free method to eliminate methane from septic tanks would be highly desirable. Filtering the organic material out of the sewage before the sewage enters the septic tank doesn't eliminate the potential for methane emissions from sewage. Removing the organic solids from the water transporting it to the septic tank, then moving and treating the organic solids somewhere else has a high potential of creating conditions for methanogenesis to occur, which creates methane emissions and other greenhouse gases due to transportation and eventual treatment and disposal.

Without organic solids in sewage, the aquatic environment in the septic tank will be aerobic making methanogenesis impossible. Eliminating organic solids by metabolically active soil bacteria digesting the organic solids within the septic tank, removes the carbon needed by all bacteria for energy and the creation of proteins for bacterial reproduction. Digesting the organic solids in the sewage within the septic tank eliminates any potential conditions needed for methanogenesis from sewage anywhere within the septic system including after the septic tank.

Accordingly, there remains a need in the art for a method of eliminating organic solids and sewage in man-made aquatic environments which prevents the creation of anaerobic conditions, eliminating anthropogenic methane emissions from these environments and reducing costs and improving the reliability of wastewater treatment processes downstream. Consequently, a solution is needed.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The invention provides a method of using a floating/suspended incubator aeration device, disclosed in U.S. Pat. No. 6,780,318, which is hereby incorporated in its entirety by reference, with a modified self-cleaning microfine bubble diffuser along with shaped and configured materials that together creates and maintains the formation of foam vs bubbles in liquid creating a constant gaseous atmospheric non-depletable oxygen environment within the incubator device necessary to incubate metabolically superior soil bacteria and create dissolved oxygen, aerobic conditions in the aquatic environment of a septic tank, mitigating or eliminating methane emissions by eliminating anaerobic conditions within the aquatic environment of a septic tank; eliminating the organic solids entering a septic tank each day through aerobic soil bacteria digestion, releasing carbon dioxide rather than methane. The modified self-cleaning microfine bubble diffuser and configuration of internal components creates the unique non-depletable atmospheric gaseous oxygen environment that allows exponential or log phase bacterial reproduction responsible for the complete elimination of organic solids entering a septic tank.

In one aspect of the invention, a method of eliminating organic solids in an aquatic environment by incubating metabolically superior soil bacteria; providing the required atmospheric gaseous non-depletable oxygen environment within the incubator device; microfine bubbles and liquid moving upward in the air lift design of the incubator device through specifically shaped and configured host material turns into foam within a bacteria host material situated above a self-cleaning microfine bubble diffuser; the liquid film of the foam bubbles are constantly renewed and broken again against the bacteria host material, exposing the interior atmosphere of the foam bubbles directly to the surface of the bacteria host material; comprising a floating/suspended incubator device comprising a self-cleaning microfine bubble diffuser configured with other interior components within a vertical outer housing to create an atmospheric gaseous non-depletable oxygen environment within the vertical column; and, an air pipe connecting the self-cleaning microfine bubble diffuser to a linear air pump; positioning the floating/suspended incubator device within the aquatic environment of a septic tank; operating the suspended incubator device to maintain a specific depth in the aquatic environment; to optimally incubate introduced metabolically active soil bacteria sufficient to digest and thereby eliminate all organic solids; create an aerobic dissolved oxygen aquatic environment throughout the septic tank; aquatic discharging an effluent from which methanogenic precursors have been eliminated; and, resulting in the elimination of methane emissions from the entire construction of a septic system.

In one embodiment, the floating/suspended incubator aeration device further comprises buoyant and counterbalanced weight structures configured to raise the floating/suspended incubator aeration device to an optimal operational depth and orientation once air is supplied to the air diffuser. In another embodiment, the optimal operational depth of the floating aeration device is approximately 12 inches between the top of the floating/suspended incubator aeration device and a surface of the aquatic environment, and the optimal orientation of the floating aeration device is vertical. In another embodiment, the floating/suspended incubator aeration device is resting on a bottom surface of an aquatic environment or suspended within an aquatic environment when air is not being supplied to the air diffuser. In one embodiment, the air diffuser is a microfine bubble diffuser fabricated from flexible EPDM or a similar elastomeric membrane material having a plurality of opening and closing micro-slits vs holes that are constantly open. In yet another embodiment, the self-cleaning microfine bubble air diffuser is oriented vertically or at an incline to prevent sediment accumulation on the micro-slits of the microfine air diffuser. In yet another embodiment, the flexible EPDM microfine bubble air diffuser is self-cleaning by connecting to pulsating airflow generated by linear air pumps causing the micro-slits to rapidly open and close as the air pulses pass through the diffuser; disallows sediment accumulation or colonization of the micro-slits by filamentous bacteria colonies or any other bacteria that would normally clog a constantly open hole. In one embodiment, the floating/suspended aeration incubation device further comprises a bacteria host material of a shape and configuration to force the vertically moving microfine bubbles and liquid to form a temporary and consistent liquid foam environment creating the required atmospheric gaseous non-depletable oxygen environment within the incubator device for soil bacteria to and flourish within the interior of the incubator device. The soil bacteria are able to digest and eliminate all of the organic solids that enter the septic tank each day. In one embodiment, the floating/suspended incubator aeration device further comprises a preloaded time-release bacterial inoculum formulated to dissolve over a month and daily release billions of soil bacteria to ensure rapid colonization of the soil bacteria on the host material. In one embodiment, the floating/suspended incubator aeration device further comprises one or more liquid inlet holes. In one embodiment, the floating/suspended incubator aeration device is configured to produce liquid circulation on the order of approximately 45,000 gallons per day. In one embodiment, the floating/suspended incubator aeration device operates at an electrical power consumption of less than 120 W and has minimal maintenance requirements. In one embodiment, two or more floating/suspended incubator aeration devices are provided and positioned within the aquatic environment. In one embodiment, the aquatic environment is the inlet chamber of a two-chamber septic tank and either or both ends of a single chamber septic tank. In one embodiment, the floating/suspended incubator aeration device is positioned within an aquatic environment through an existing four-inch diameter or greater monitoring port or similar structure. In one embodiment, the aquatic environment is a septic tank installed on a sewer lateral connecting a sewage producing site to a sewer main running to a wastewater treatment facility.

In another embodiment, a further step of measuring or modeling the elimination of methane and dramatic reduction of other greenhouse gas emissions as CO2 equivalent (CO2e) carbon credits or in carbon emission trading schemes is provided. In another aspect of the invention, a method for on-site wastewater treatment that eliminates methane gas emissions and dramatically reduces CO2 gas emissions is provided, comprising installing a floating/suspended incubator aeration device with a self-cleaning microfine bubble air diffuser and other required interior materials, designed to be installed in an anaerobic septic tank; introducing air at a rate that creates a non-depletable atmospheric gaseous oxygen environment within the incubator device, vs a highly depletable aerobic dissolved oxygen liquid environment, creating the required high energy atmospheric gaseous non-depletable oxygen environment soil bacteria require to colonizing and rapidly reproduce over anaerobic activity; eliminating methane formation by sustaining dissolved oxygen levels necessary for continuous aerobic conditions of the aquatic environment of a septic tank; converting organic waste to carbon dioxide instead of methane, eliminating a septic system's overall greenhouse gas footprint.

The foregoing has outlined rather broadly the more pertinent and important features of the present disclosure so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE DRAWINGS

Other features and advantages of the present invention will become apparent when the following detailed description is read in conjunction with the accompanying drawings, in which:

FIG. 1 is a cross-section view of a floating aeration device according to an embodiment of the present invention.

FIG. 2 is a top view of a floating/suspended incubator aeration device according to an embodiment of the present invention.

FIG. 3 is a bottom view of a floating/suspended incubator aeration device according to an embodiment of the present invention.

FIG. 4A is a side view of a floating/suspended incubator aeration device at rest in a septic tank according to an embodiment of the present invention.

FIG. 4B is a side view of a floating/suspended aeration device in operation in a septic tank according to an embodiment of the present invention.

FIG. 5A is a side sectional view of a floating/suspended aeration device at rest in a deep tank or pit according to an embodiment of the present invention.

FIG. 5B is a side sectional view of a floating/suspended aeration device in operation in a deep tank or pit according to an embodiment of the present invention.

FIG. 6 is a diagram illustrating the installation of a floating/suspended aeration device through a monitoring port of a septic tank according to an embodiment of the present invention.

FIG. 7 is a top view of a monitoring port of a septic tank through which a floating/suspended aeration device is installed according to an embodiment of the present invention.

FIG. 8 is a close-up view of a connection between an air pipe and a flex tubing in a monitoring port of a septic tank for supplying air to a floating/suspended aeration device according to an embodiment of the present invention.

FIG. 9 is a schematic diagram of a treatment tank installed on a lateral sewer line between a sewage producing site and a sewer main leading to a wastewater treatment facility, according to an embodiment of the present invention.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a system and method for methane elimination in septic systems and other aquatic environments and method to create carbon credits or their equivalent.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. The term “eliminating” is defined herein to mean a reduction of at least 95%. The term “approximately” is defined herein to mean within ±10%. These terms generally refer to a range of numbers that one of skill in the art would consider equivalent to the recited values (i.e., having the same function or result). In many instances these terms may include numbers that are rounded to the nearest significant figure.

As used herein, the terms “aerobic,” “aerobic conditions,” and “aerobic digestion” are not limited to the mere presence of dissolved oxygen within the bulk liquid of a wastewater stream. In the present disclosure, the floating/suspended incubator aeration device is configured to create, within an interior region of the device, an atmospheric gaseous non-depletable oxygen environment that is distinct from the surrounding liquid phase. More particularly, upwardly moving microfine bubbles and liquid are caused, by the shape and configuration of the bacteria host material within the outer housing, to form a temporary upwardly moving foam such that bacteria colonizing the host material are repeatedly exposed to oxygen contained within the foam bubbles rather than relying solely on dissolved oxygen in the surrounding wastewater. This gaseous oxygen environment supports colonization, survival, and reproduction of soil facultative anaerobic bacteria within the device, while operation of the device may also increase dissolved oxygen in the surrounding aquatic environment sufficient to maintain aerobic conditions in the wastewater outside the device. Accordingly, unless the context indicates otherwise, references herein to “aerobic” may refer to either or both of: (i) a gaseous, substantially continuously replenished oxygen environment within the device, and (ii) a dissolved-oxygen-containing liquid environment in the surrounding wastewater, with the former being distinct from and not limited to the latter.

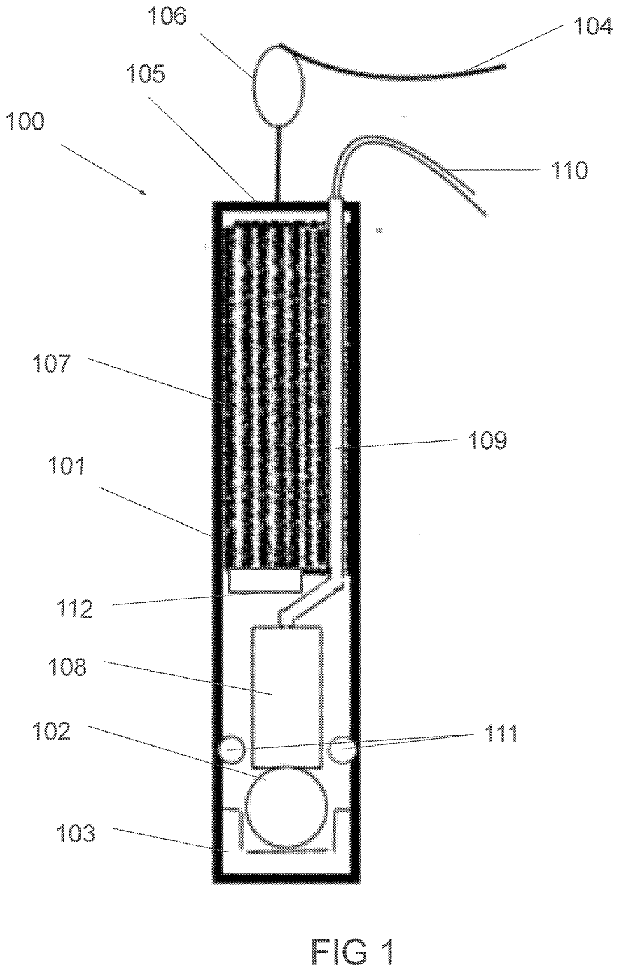

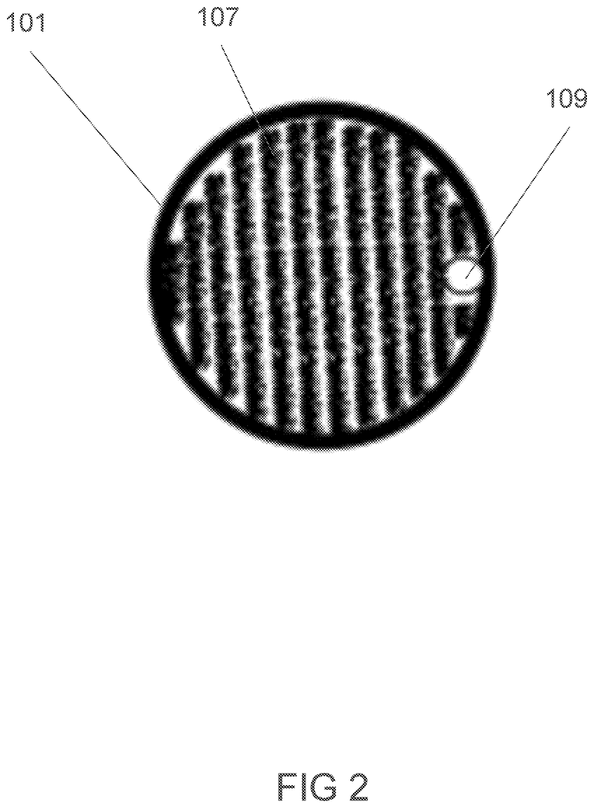

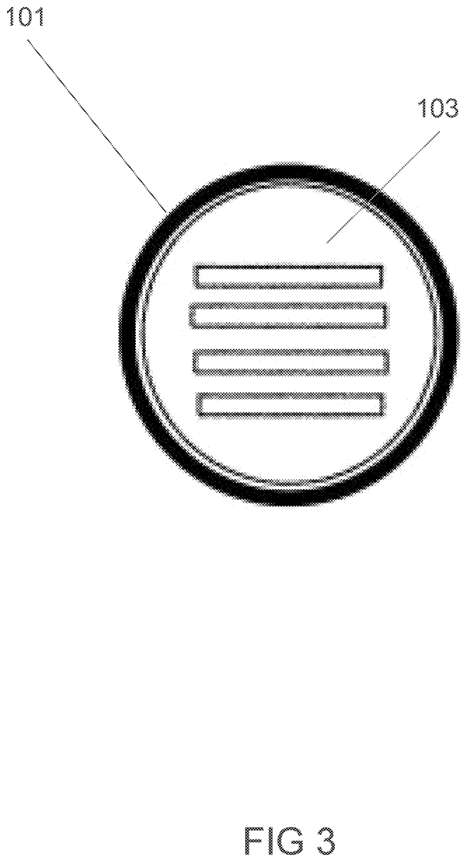

In some embodiments, the present invention provides a floating/suspended incubator aeration device 100 as seen in FIGS. 1-3, designed to eliminate methane emissions in standard septic tanks by converting an anaerobic aquatic environment into an oxygen-rich environment and removing organic substrate. In some embodiments, the invention incorporates a housing 101 weighted to counteract buoyant forces generated during aeration. In some embodiments, the housing contains a counterbalance weight 102 and a bottom insert 103 with drain slots which also serves as a counter weight. The drain slots enable water to drain out of the device when it is removed from a wastewater volume. In some embodiments, a support rope 104 is connected to the top 105 of the floating/suspended aeration device and a float 106 is connected to the support rope. Advantageously, the float, housing, counterbalance weight and bottom insert with drain slots are configured to suspend the device in an optimal position and orientation during aeration. In some embodiments, the optimal position and orientation of the device is with the device top approximately 12 inches below the liquid surface and having a vertical orientation. In some embodiments, this optimal position and orientation is independent of overall tank liquid depth and ensures uniform hydraulic and biological performance across installations, ensuring effective contact between the incoming waste, oxygen, and specialized bacteria.

In some embodiments, the device includes a bacteria host material 107 configured both to support bacterial colonization and to shape fluid and bubble flow within the housing so as to promote formation of the temporary foam environment described herein. In some embodiments, the housing contains a time-release bacterial inoculum 112 formulated to dissolve, releasing billions of bacteria daily to ensure rapid colonization of the bacteria host material. In some embodiments, the bacterial inoculum is configured to dissolve over a period of approximately three to four weeks,

In some embodiments, the floating aeration device builds upon earlier approaches by incorporating a self-cleaning flex membrane tube diffuser 108 that enhances oxygen distribution and supports continuous digestion by bacteria requiring atmospheric gaseous non-depletable oxygen rather than merely dissolved oxygen. In some embodiments, the diffuser is a microfine bubble diffuser configured to create optimal atmospheric conditions within the floating aeration device. In some embodiments, the diffuser is fabricated from flexible EPDM or a similar elastomeric membrane material having a plurality of micro-slits (not shown). In some embodiments, the diffuser is oriented vertically or at an incline to prevent sediment accumulation on the micro-slits of the diffuser.

In some embodiments, the diffuser is coupled to a linear air pump (not shown) located remotely and near an electrical outlet via a diffuser air supply pipe 109. In some embodiments, air is conveyed from the pump through buried piping or flexible tubing 110 into a tank riser and into the device. When air is supplied to the diffuser, the micro-slits open to release microfine bubbles. When air flow ceases or pulses, the micro-slits close, mechanically expelling accumulated debris. Linear air pumps inherently generate pulsating airflow, causing repeated opening and closing of the slits and thereby continuously cleaning the diffuser during normal operation. This configuration eliminates the need for manual cleaning and ensures consistent long-term airflow. When energized, the air pump supplies oxygen in sufficient volume and pressure to the diffuser to create a substantially atmospheric, gaseous, non-depletable oxygen environment within the device. In some embodiments, the diffuser emits air into the aquatic environment in a vertical column so that the air passes through the bacteria host material configured to be directly above the diffuser. In some embodiments, the device further comprises one or more liquid inlet holes 111 through which wastewater enters the device. In some embodiments, the bacteria metabolize organic material entering the septic tank as a nutrient source. In some embodiments, the limited daily mass loading of organic solids and the high reproduction rate of the bacteria result in all incoming organic solids being digested and biologically recycled within the tank. In some embodiments, the septic tank then discharges only treated effluent substantially free of methanogenic precursors into the drain field or other downstream processes of the system. In some embodiments, the system is highly cost-effective, operating at low electrical power consumption of less than 120 W and having minimal maintenance requirements.

In some embodiments, the bacteria host material 107 is not merely a bacterial support medium, but is specifically shaped and configured to cooperate with the outer housing 101 and the self-cleaning microfine bubble diffuser 108 to transform the upwardly moving stream of microfine bubbles and wastewater within the housing into a temporary upwardly moving foam. This foam environment is distinct from ordinary aeration in wastewater. More particularly, the host material is arranged such that the liquid films of the foam bubbles are repeatedly renewed and broken against surfaces of the host material, thereby exposing bacteria colonizing the host material directly to the atmosphere within the foam bubbles. As a result, the bacteria are exposed to a substantially atmospheric gaseous non-depletable oxygen environment within the device, rather than relying solely on dissolved oxygen present in the surrounding tank liquid. In this manner, the shape and configuration of the host material contribute to creating and maintaining a first oxygen environment within the device that is different from the dissolved-oxygen-containing liquid environment outside the device, thereby promoting colonization, survival, and activity of the disclosed bacteria within the incubator device.

Advantageously, the design of the diffuser prevents fouling from microbial growth and extracellular polymeric substances, mineral scaling, and dust or contaminants introduced from the air supply, all of which conventional diffusers are prone to. Fouling reduces air throughput, disrupts oxygen concentration, and diminishes circulation performance.

In some embodiments, the device is configured as an air-lift pump. In some embodiments, housing dimensions and air-flow rates are selected to produce liquid circulation on the order of approximately 45,000 gallons per day. This circulation rate ensures that the entire tank volume is repeatedly passed through or adjacent to the incubator, typically 45 times per day, thereby maximizing contact between organic solids and the bacterial population.

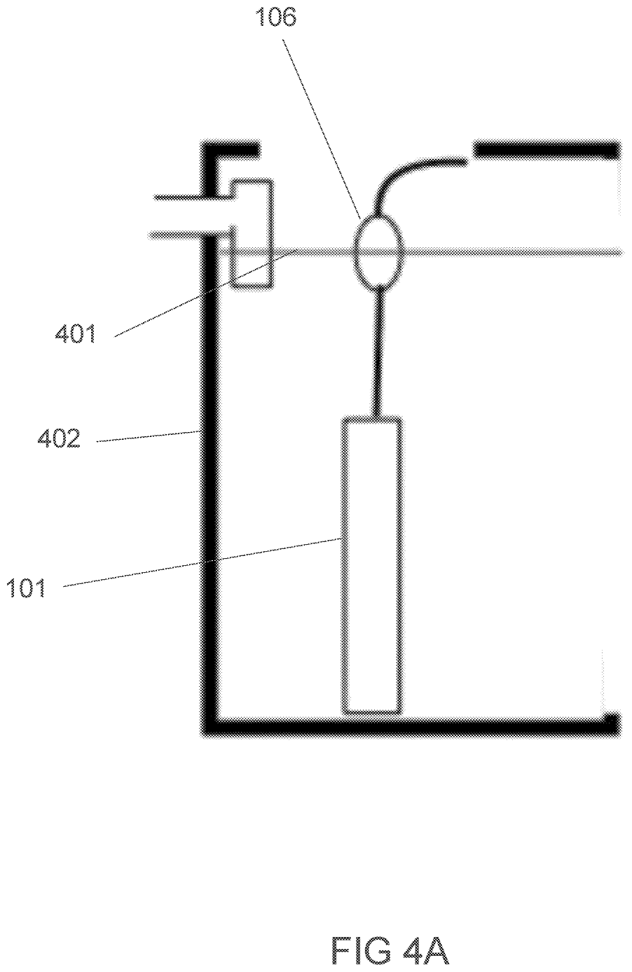

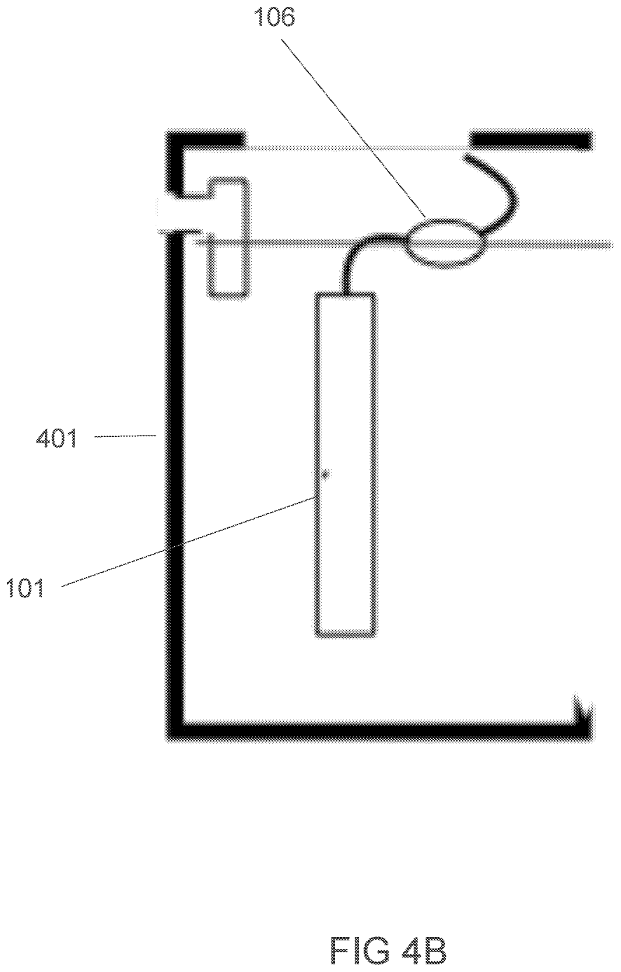

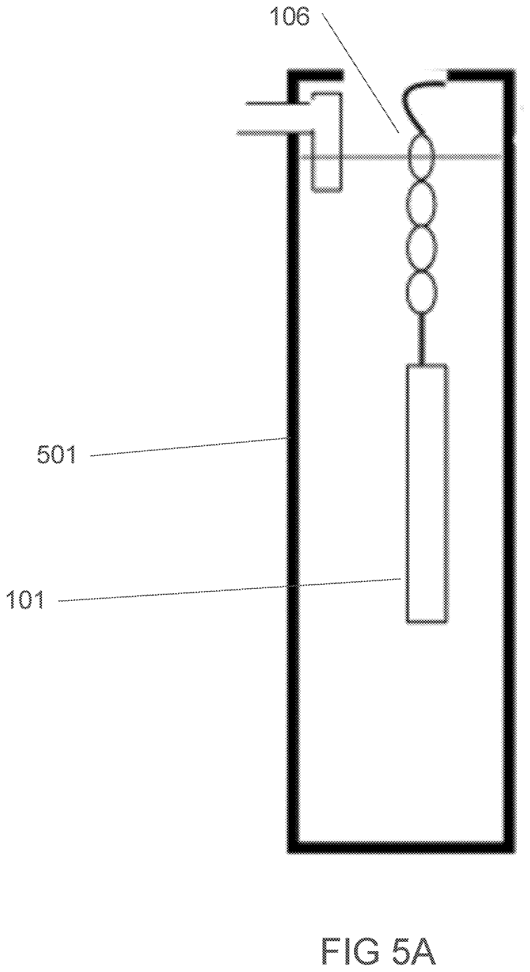

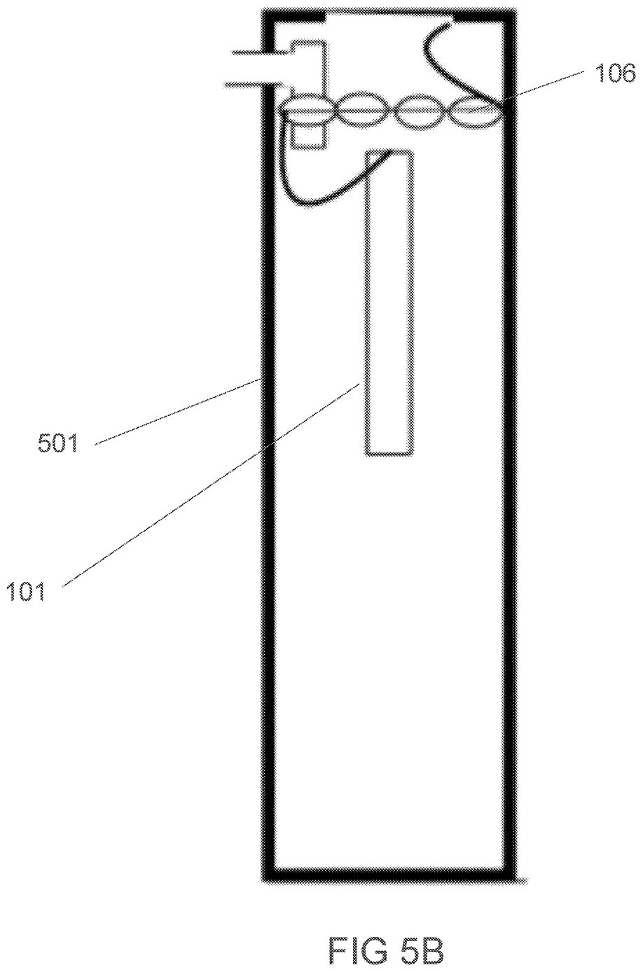

Now referring to FIGS. 4A-B the operation of the floating aeration device with a single float resting on the water surface 401 is shown. In some embodiments, when the device is not aerating, it may be resting on the bottom of a septic tank 402 as seen in FIG. 4A. In some embodiments, when the device is aerating, it floats up to an optimal water depth and vertical position as a result of the balancing of forces between the lift provided by aeration and the various weighted structures of the device. In some embodiments, the device is installed on deep tanks or pits and multiple floats may be used to prevent the device from sinking too deep into a water volume, as seen in FIGS. 5A-B. As seen in FIG. 5B, the device is still configured to rise to an optimal depth within a deep-water volume, when the device is aerating.

In some embodiments the floating/suspended aeration device is installed in the septic system through a riser or monitoring port, with the floating aerator configured to be positioned at an optimal depth within the wastewater layer. In some embodiments, the aeration device introduces a steady supply of air via an air pipe 605 and flexible tubing 606 connected to an external air pump 607. In some embodiments, one or more floating aeration devices may be installed within a given riser or monitoring port.

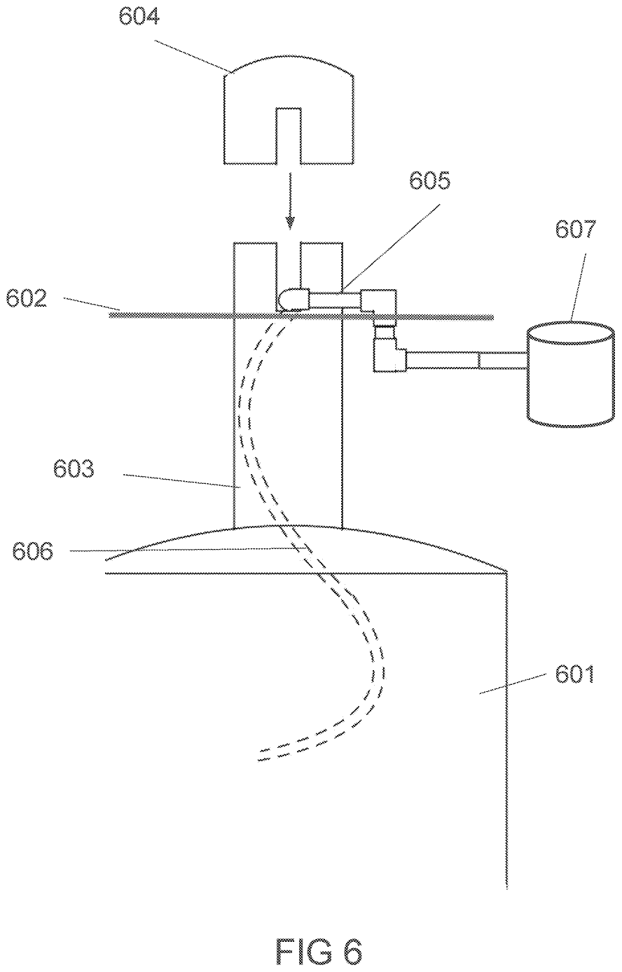

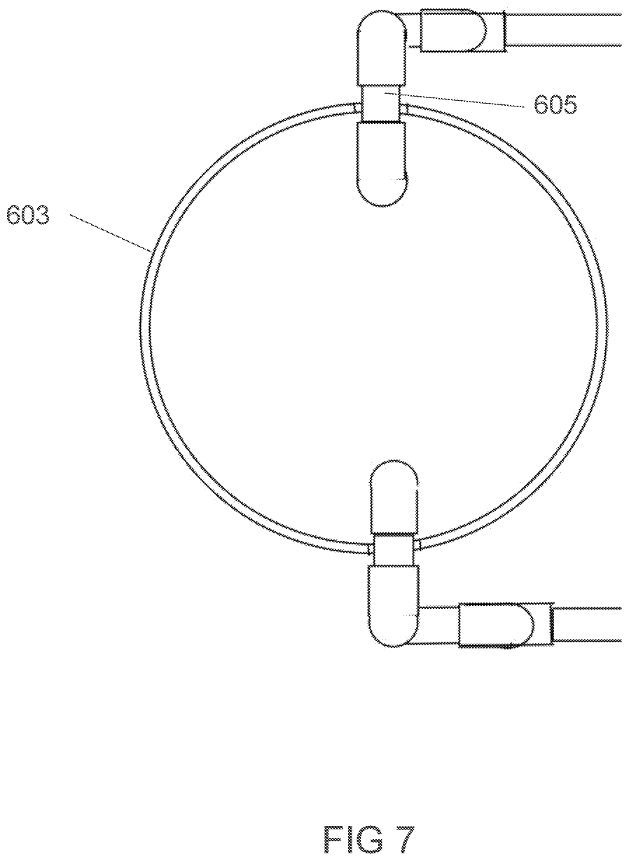

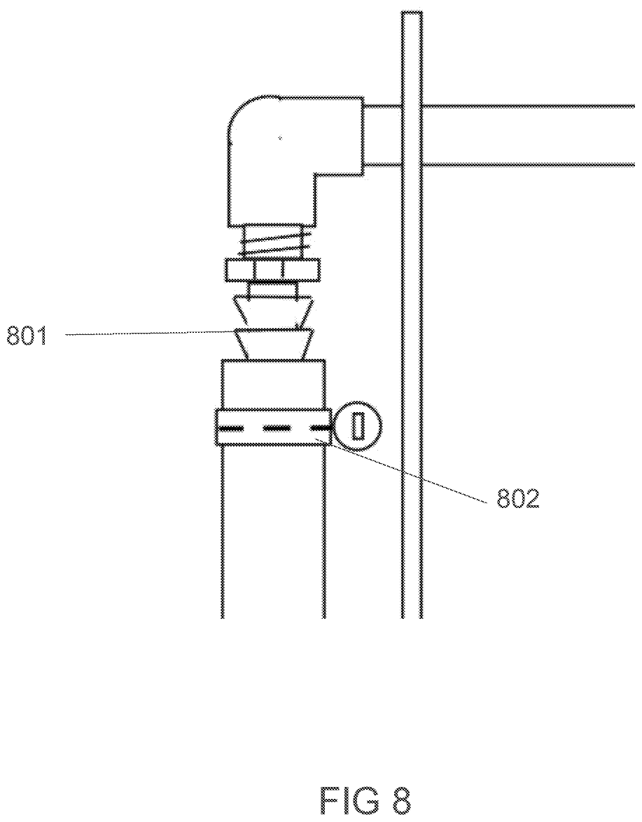

Now referring to FIGS. 6-8, an example of the floating aeration device installed through a monitoring port into a generic vessel or tank is illustrated. It should be noted that the device may be beneficially installed in various locations within a septic system using a monitoring port or other means of access. A vessel 601 which may be positioned below grade 602, has an attached riser 603 enabling access to the vessel. In some embodiments, the riser is a 4″ diameter pipe. In some embodiments, a riser end cap 604 attaches to the top side of the riser in order to provide a lid to the riser. In some embodiments, the riser and riser end cap are each notched to receive an air pipe 605 that feeds a steady stream of air to the aeration device inside the vessel from a pump 607 located outside of the vessel. In some embodiments, the air pipe is a ½″ PVC pipe. On the inside of the riser, in some embodiments the air pipe attaches to a flexible tube 606 which connects the air pipe with the aeration device positioned within the vessel. In some embodiments, the connection between the air pipe and the flexible tube is made using a male-to-barb adapter 801 with a clamp 802 around the flexible tube to provide additional sealing force against the adapter.

Advantageously, because the diffuser has been adapted to deliver air more efficiently, the device ensures that dissolved oxygen levels remain high throughout the tank contents. However, the system also facilitates exposure to atmospheric oxygen within the liquid column, sustaining specialized microbial populations that thrive on non-depletable gaseous oxygen rather than limited dissolved oxygen alone. This shift from anaerobic to aerobic conditions suppresses the microbial pathways that produce methane and instead encourages microorganisms that release carbon dioxide. By maintaining aerobic digestion on a continuous basis, the system also prevents significant sludge accumulation, thereby reducing or eliminating the need for traditional pumping services. In addition, any previously “stored” methane in an existing anaerobic septic system is gradually consumed as aerobic digestion becomes dominant, further reducing greenhouse gas impacts over time.

During use, an installer accesses the septic tank through an existing riser or monitoring port, inserts the floating aerator into the liquid layer of the tank, and secures the external air line. Once the air pump is engaged, the floating/suspended aerator naturally ascends to the correct operating depth, where it maximizes oxygen transfer and fosters the aerobic bacterial colony. The aerator's buoyant design allows it to hover at a level that maximizes contact with incoming waste, promoting rapid biological digestion of solids. Over time, the tank maintains a state of ongoing microbial activity, fueled by the reliable oxygen supply from the air pump. As a result, the normal buildup of organic solids that often necessitates pumping is greatly diminished or eliminated. Routine checks, typically on an annual basis, can confirm the system's continued effectiveness and diffuser integrity without requiring invasive procedures or excavation.

Advantageously, the invention offers a practical, low-energy approach to addressing the overlooked methane emissions produced by conventional anaerobic septic tanks. By integrating easily into existing systems and operating with minimal user intervention, it provides both an environmental benefit through reductions in greenhouse gases and an economic benefit, as pumping expenses are curtailed. Because the device is introduced through the riser, there is no damage to the surrounding landscape. Additionally, the modified diffuser design allows for variations in capacity and application, making the technology versatile enough to handle different levels and types of wastewater loading. Larger units or multiple aeration devices can be installed if greater throughput is needed, ensuring the system is not limited to a single configuration. It can be adapted for household, industrial, agricultural, or other settings where on-site waste treatment is necessary. This flexibility, combined with the system's operational simplicity, underscores the potential for widespread adoption of the invention and resulting reductions in methane emissions from decentralized wastewater treatment processes.

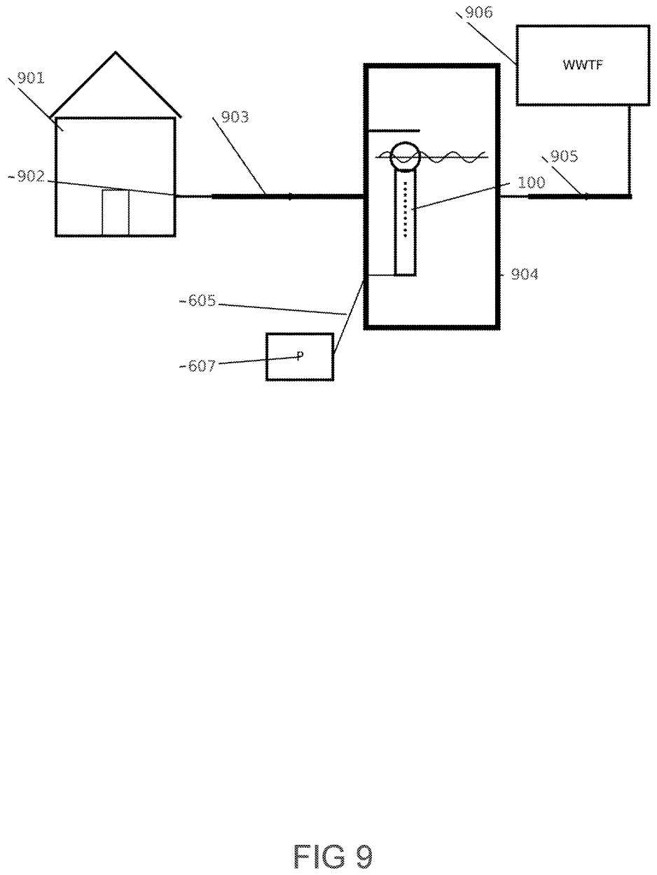

In some embodiments, the floating aeration device is installed in a tank located on a sewer lateral between one or more residences or other wastewater producers and the sewer main carrying sewage from residences to a wastewater treatment plant. In these embodiments, there is no leach field and the wastewater treatment plant acts as final disposal for the sewage. The same principles are applied in these embodiments, with a dedicated treatment tank equipped with one or more devices installed on the sewer lateral between the building discharge point and the sewer main. The tank is operated in a similar manner as a septic tank equipped with the device. Organic solids are digested aerobically prior to entry into the municipal wastewater collection system, and the effluent delivered to the wastewater treatment plant contains substantially no organic substrate capable of supporting methanogenesis. Accordingly, methane generation a FIG. 1 is a side view of a floating aeration device attributable to human sewage is eliminated or materially reduced throughout the entire treatment process. Now referring to FIG. 9, in some embodiments, the aquatic environment is provided within a treatment tank 904 located on a lateral sewer line 903 that connects a sewage producing site 901 (e.g., a residence or facility) to a sewer main 905 leading to a wastewater treatment facility 906. One or more floating aeration devices 100 are positioned within the treatment tank 904 and operated to maintain aerobic conditions in the aquatic environment therein prior to discharge to the sewer main 905.

Advantageously, the aeration device eliminates methane emissions from within the infrastructure of the sewer lines. Typically, as water and sewage flow within the sewer lines, the mixing of sewage within the water creates anaerobic conditions which leads to methanogenesis. However, the constant introduction of bacteria generated from the floating aeration devices installed on the sewer laterals digest and recycle the sewage in the liquid flow within the sewer lines over time, eliminating anaerobic conditions in the sewer lines and halting methanogenesis.

With a sufficient number of residential installations of floating aeration devices installed in sewer laterals between residences and sewer mains, the sewer mains become a treatment process rather than merely a transportation process. As the sewage travels along the sewer line, the mixing and aeration of the sewage flow causes digestion and recycling of sewage prior to the wastewater treatment plant reducing the cost of operating the treatment plant.

Additionally, the production of hydrogen sulfide gas (H2S) is eliminated with the creation of aerobic conditions in the sewage flow. Acidithiobacillus bacteria, an extremophile capable of surviving in pure sulfuric acid, uses hydrogen sulfide gas as an electron donor for energy. This multistep chemical process leaves sulfuric acid as a byproduct. Acidithiobacillus forms biofilms rich in sulfuric acid on surfaces near where H2S is formed, which is the primary mechanism by which concrete sewer pipes dissolve and fall apart and require major sewer line replacement. Hence, the cost of maintenance and replacement of sewer infrastructure is dramatically reduced by eliminating the production of H2S.

Lastly, wastewater treatment plants often discharge treated waste outside of their design limits and need solutions to avoid this. One method to improve the treatment process of the wastewater plant is to continuously add facultative anaerobic bacteria to the secondary aeration treatment process for a prescribed period. This process of bioaugmentation is expensive, whereas the constant introduction of bacteria, including facultative anaerobic bacteria species and strains from the floating aeration devices on the sewer laterals is a continuous bioaugmentation that is cost-free for the wastewater plant.

It should be noted that the floating aeration device is effective at eliminating methane emissions in any aquatic environment by enabling the breakdown of organic solids. In some embodiments, the aeration device can be used in any aquatic environment within a septic system including but not limited to the inlet to a septic tank, anywhere inside a septic tank, or at the outlet of a septic tank. In a preferred embodiment for residential septic systems, the floating aeration device is installed in the inlet chamber of a two-chamber septic tank via a riser extending to ground level to permit access for installation and maintenance. In another preferred embodiment for residential single-chamber tanks, two devices are installed: one near the inlet end and one near the outlet end, thereby preventing accumulation of floating solids in regions remote from the aeration source.

In some embodiments, the floating aeration device may be used not only in septic tanks or lateral sewer lines, but also in aquatic environments such as water ponds, pits, and impoundments at oil and gas production facilities where organic-rich sediments accumulate and anaerobic conditions typically persist. In some embodiments, the aeration device can be used in aquaculture farms, agricultural ponds or canals including rice paddies and manure lagoons at livestock facilities, stormwater ponds and facilities, and mining sites such as coal mining tailings ponds. In some embodiments, the aeration device can be used in any aquatic environment associated with an on-site wastewater system, including but not limited to an inlet to a septic tank, anywhere inside a septic tank, an outlet of a septic tank, a cesspool, a cesspit, a seepage pit, or a treatment tank located on a lateral sewer line between a sewage-producing site and a sewer main.

Advantageously, as the invention eliminates organic solids in an aquatic environment, the water produced from the aerobic wastewater treatment may be utilized for local applications where water and/or nutrients are beneficial including but not limited to firefighting, flushing, industrial cooling, and fertilizer application. In some embodiments, the application of the floating aeration device in a septic system enables the septic liquid to be used to fight fire or to be used to water and fertilize lawns or other plants.

Advantageously, the elimination of methane emissions from aquatic environments such as septic tanks or sewer lines can be integrated into the carbon economy through carbon credits or carbon emissions trading. Where organic solids are verified to be fully eliminated from an aquatic environment due to an installation of the floating aeration device, methanogenesis can be confirmed as fully eliminated, meaning that all previous emissions of carbon as methane from the aquatic environment have been converted to carbon emissions as carbon dioxide and the climate change impact of this conversion can be easily quantified and credited. Hence, the invention further comprises a method for creating carbon credits by verifiably eliminating anthropogenic methane from septic systems or other man-made systems with aquatic environments. Carbon credits are a financial asset with tangible value and are saleable in marketplaces worldwide where they are traded. The elimination of organic solids from an aquatic environment is the only known practical method of eliminating anthropogenic methane emissions from septic systems or other similar man-made systems.

For carbon accounting, methane emissions may be measured via two main methods: bottom-up and top-down. In some embodiments, a bottom-up approach is used for determining the amount of carbon credits an installation of the floating aeration device produces. This approach begins at an individual site with a localized source of methane such as a septic system, and can then be expanded to a larger scale such as multiple septic systems in a neighborhood. These assessments can either be based on direct measurements of given methane emissions or by modeled values for the production of waste from a given household, facility or piece of equipment. For example, to estimate the methane produced by a region's or country's septic systems, a bottom-up approach would multiply the methane emitted by a typical septic system by the number of septic systems having the technology installed. A similar approach could be used to calculate the methane released by a county's natural gas facilities or a region's oil drilling operations.

In some embodiments, greenhouse gas reduction attributable to installation and operation of the floating/suspended incubator aeration device is quantified for carbon accounting using direct measurement, modeled estimation, standardized emission factors, engineering calculations, baseline assumptions for untreated wastewater systems, or combinations thereof. In some embodiments, the quantified reduction is determined for a single installation or is aggregated across a plurality of installations, including septic tanks, cesspools, cesspits, seepage pits, or treatment tanks on sewer laterals. In some embodiments, the quantified reduction is reported to a carbon registry, environmental credit program, governmental agency, or private verification body and may be issued, recorded, transferred, sold, retired, or otherwise accounted for as carbon credits, carbon offsets, emissions-reduction credits, or equivalent environmental attributes. In some embodiments, standardized or conservative default values are used to estimate methane emissions avoided by untreated systems, thereby reducing or eliminating a need for site-specific baseline methane measurements before installation. In some embodiments, operation of the device is monitored using one or more recorded parameters including air pump runtime, airflow rate, maintenance records, wastewater loading, solids reduction, dissolved oxygen, or other indicators correlated with methane elimination.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. In other words, the terminology and phraseology used in this description and the abstract are for illustrative purposes and should not be considered limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and etc. members throughout the disclosure (and in particular, claims) are not used to show a serial or numerical limitation but instead are used to distinguish or identify the various members of the group.

What is claimed is:

1. A method of eliminating organic solids in an aquatic environment, comprising:
providing a floating/suspended incubator aeration device comprising:
an outer housing;
a self-cleaning microfine bubble diffuser positioned within the outer housing;
an air pipe connecting the self-cleaning microfine bubble diffuser to an air pump; and
a bacteria host material positioned above the self-cleaning microfine bubble diffuser within the outer housing;
positioning the floating/suspended incubator aeration device within the aquatic environment;
supplying air to the self-cleaning microfine bubble diffuser such that microfine bubbles and liquid move upwardly within the outer housing through the bacteria host material;
wherein the bacteria host material is shaped and configured to cause the upwardly moving microfine bubbles and liquid to form a temporary upwardly moving foam within the outer housing, the foam exposing bacteria colonizing the bacteria host material to atmospheric gaseous non-depletable oxygen within foam bubbles;
thereby maintaining within the device an atmospheric gaseous non-depletable oxygen environment that is distinct from dissolved oxygen in the surrounding aquatic environment;
digesting organic solids in the aquatic environment by bacteria colonized on the bacteria host material; and
discharging treated effluent from which methanogenic precursors are reduced or eliminated, thereby reducing or eliminating methane emissions from the aquatic environment.

2. The method of claim 1, wherein the floating/suspended incubator aeration device further comprises buoyant and counterbalanced weight structures configured to raise the floating/suspended incubator aeration device to an optimal operational depth and orientation once air is supplied to the air diffuser, in order to maximize oxygen transfer to incoming organic waste.

3. The method of claim 2, wherein the optimal operational depth is approximately 12 inches between a top of the floating/suspended incubator aeration device and a surface of the aquatic environment, the device being maintained in a substantially vertical orientation during operation, such that operation of the device is substantially independent of overall liquid depth of the aquatic environment and hydraulic and biological performance is substantially uniform across installations.

4. The method of claim 2, wherein the floating/suspended incubator aeration device is resting on a bottom surface of an aquatic environment or floating within an aquatic environment when air is not being supplied to the air diffuser.

5. The method of claim 1, wherein the air diffuser is a microfine bubble diffuser fabricated from flexible EPDM or a similar elastomeric membrane material having a plurality of micro-slits.

6. The method of claim 5, wherein the air diffuser is oriented vertically or at an incline to prevent sediment accumulation on the micro-slits of the air diffuser.

7. The method of claim 5, wherein the air diffuser is self-cleaning as a result of pulsating airflow passing through it.

8. The method of claim 1, wherein the bacteria host material is shaped and configured to force upwardly moving microfine bubbles and liquid within the outer housing into a temporary foam environment that repeatedly exposes bacteria colonizing the bacteria host material to atmospheric oxygen within the foam bubbles.

9. The method of claim 8, wherein liquid films of the foam bubbles are repeatedly renewed and broken against surfaces of the bacteria host material such that the bacteria are exposed to a gaseous oxygen environment within the device rather than relying solely on dissolved oxygen in the surrounding aquatic environment.

10. The method of claim 8, wherein the floating/suspended incubator aeration device further comprises a time-release bacterial inoculum formulated to dissolve and release billions of bacteria daily to ensure rapid colonization of the bacteria host material.

11. The method of claim 1, wherein the floating aeration device further comprises one or more liquid inlet holes.

12. The method of claim 1, wherein the floating aeration device is configured to produce liquid circulation on the order of approximately 45,000 gallons per day.

13. The method of claim 1, wherein the floating/suspended incubator aeration device operates at an electrical power consumption of less than 120 W and has minimal maintenance requirements.

14. The method of claim 1, wherein two or more floating/suspended incubator aeration devices are provided and positioned within the aquatic environment.

15. The method of claim 1, wherein the aquatic environment is any part of a septic system including an inlet to a septic tank, a septic tank, an outlet of a septic tank, a cesspool, a cesspit, or a seepage pit.

16. The method of claim 1, wherein the floating/suspended incubator aeration device is positioned within an aquatic environment through an existing monitoring port or similar structure.

17. The method of claim 1, wherein the aquatic environment is located on a lateral sewer line connecting a sewage producing site to a sewer main running to a wastewater treatment facility.

18. The method of claim 1, wherein the aquatic environment is a water pond, pit, or impoundment at an oil or gas production facility where organic-rich sediments accumulate.

19. The method of claim 1, further comprising measuring or modeling the reduction of greenhouse gas emissions from the providing of the floating/suspended incubator aeration device in the aquatic environment and accounting for the reduction of greenhouse gas emissions as carbon credits or in carbon emission trading schemes.

20. A method for on-site wastewater treatment that minimizes greenhouse gas emissions, comprising:
installing a floating/suspended incubator aeration device in an anaerobic septic system;
introducing air to a self-cleaning microfine bubble diffuser within the device at a rate sufficient to create within the device a substantially atmospheric gaseous non-depletable oxygen environment distinct from dissolved oxygen in surrounding wastewater;
exposing bacteria colonized on shaped and configured host material within the device to the atmospheric gaseous oxygen environment;
digesting organic waste in the septic system so as to suppress methanogenesis; and
discharging treated wastewater with reduced methane-forming potential.
